(19) United States
(12) Patent Application Publication
(10) Pub. No.: US 2026/0089716 A1
(43) Pub. Date: Mar. 26, 2026

(54) METHOD AND DEVICE FOR SPLIT BEARER OPERATION IN WIRELESS COMMUNICATION SYSTEM

(71) Applicant: Samsung Electronics Co., Ltd., Suwon-si, Gyeonggi-do (KR)

(72) Inventors: Taeseop LEE, Suwon-si (KR); Sangkyu BAEK, Suwon-si (KR); Anil AGIWAL, Suwon-si (KR); Hyunjeong KANG, Suwon-si (KR)

(21) Appl. No.: 19/109,399

(22) PCT Filed: Sep. 25, 2023
(86) PCT No.: PCT/KR2023/014584

§ 371 Date: Mar. 6, 2025

(30) Foreign Application Priority Data
Sep. 29, 2022 (KR) 10-2022-0124185

(51) Int. Cl. H04W 72/20; H04W 72/51; H04W 72/543; H04W 80/02

(52) U.S. Cl. CPC H04W 72/20; H04W 72/51; H04W 72/543; H04W 80/02

(57) ABSTRACT

The present disclosure relates to a 5G or 6G communication system for supporting higher data transmission rates. Disclosed is a method performed by a terminal in a wireless communication system, the method comprising the steps of: receiving, from a base station, configuration information for establishing a radio link control (RLS) bearer for first and second data sets; identifying the first and second data sets included in a single data radio bearer (DRB); allocating the first and second data sets to multiple RLC bearers on the basis of the configuration information; and transmitting the first and second data sets through the multiple RLC bearers.

### CROSS-REFERENCE TO RELATED APPLICATION(S)

This application is a U.S. National Stage application under 35 U.S.C. §371 of an International application number PCT/KR2023/014584, filed on Sep. 25, 2023, which is based on and claims priority of a Korean patent application number 10-2022-0124185, filed on Sep. 29, 2022, in the Korean Intellectual Property Office, the disclosure of which is incorporated by reference herein in its entirety.

### TECHNICAL FIELD

The disclosure relates to operations of a UE and a gNB in a wireless communication system and, more particularly, to a method and a device for operating a split bearer.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of mobile communication systems as described above, various services can be provided, and accordingly there is a need for ways to effectively provide these services, in particular, ways to efficiently operate split bearers.

### DISCLOSURE OF INVENTION

### Technical Problem

Embodiments set forth herein are to provide a device and a method capable of effectively providing services in a wireless communication system.

### Solution to Problem

According to an embodiment of the disclosure, a method performed by a terminal in a wireless communication system may include: receiving, from a base station, configuration information for configuring a radio link control (RLC) bearer for a first data set and a second data set; identifying the first data set and the second data set included in one data radio bearer (DRB); allocating the first data set and the second data set to multiple RLC bearers, based on the configuration information; and transmitting the first data set and the second data set through the multiple RLC bearers, wherein the first data set and the second data set may have different QoS requirements.

The method may further include: receiving, from the base station, a UECapabilityEnquiry message requesting information regarding whether a data set-based bearer configuration is supported; and transmitting, to the base station, a UECapability Information message including the information regarding whether a data set-based bearer configuration is supported.

The configuration information may include a first threshold for determining whether or not to operate a split bearer for the first data set and a second threshold for determining whether or not to operate a split bearer for the second data set. The allocating of the first data set and the second data set to multiple RLC bearers, based on the configuration information, may include: determining, based on the first threshold, at least one RLC bearer among the multiple RLC bearers as a first primary path and a first split secondary path for the first data set; determining, based on the second threshold, at least one RLC bearer among the multiple RLC bearers as a second primary path and a second split secondary path for the second data set; and allocating the first data set to the first primary path, and the first split secondary path and, allocating the second data set to the second primary path, and the second split secondary path.

The RLC bearers determined as the first primary path, the second split secondary path, the second primary path, and the second split secondary path may be different from each other.

The configuration information may include first duplication information regarding whether or not duplication is configured with regard to the first data set and second duplication information regarding whether or not duplication is configured with regard to the second data set. The allocating of the first data set and the second data set to multiple RLC bearers, based on the configuration information, may include: determining, based on the first duplication information, at least one RLC bearer among the multiple RLC bearers as a first primary path and a first secondary path for the first data set; determining, based on the second duplication information, at least one RLC bearer among the multiple RLC bearers as a second primary path and a second secondary path for the second data set; and allocating the first data set to the first primary path, and the first secondary path; and allocating the second data set to the second primary path, and the second secondary path.

The RLC bearers determined as the first primary path, the second secondary path, the second primary path, and the second secondary path may be different from each other.

The identifying of the first data set and the second data set included in one DRB may include identifying the first data set and the second data set, based on identification information included in a header in a packet, or an internal interface of the terminal.

The method may further include: receiving a MAC CE indicating whether to activate or deactivate a duplication function for at least one data set from among the first data set and the second data set; and activating or deactivating a function of duplicating at least one data set from among the first data set and the second data set and transmitting the duplicated data set to multiple RLCs, based on the MAC CE.

According to an embodiment of the disclosure, a method performed by a base station in a wireless communication system may include: transmitting, to a terminal, configuration information for configuring a radio link control (RLC) bearer with regard to each of a first data set and a second data set; and receiving the first data set and the second data set allocated to multiple RLC bearers, based on the configuration information, wherein the first data set and the second data set may have different QoS requirements.

The method may further include: transmitting, to the terminal, a UECapabilityEnquiry message requesting information regarding whether a data set-based bearer configuration is supported; and receiving, from the terminal, a UECapabilityInformation message including the information regarding whether a data set-based bearer configuration is supported.

According to an embodiment of the disclosure, a terminal of a wireless communication system may include: a transceiver; and at least one processor coupled to the transceiver, wherein the at least one processor may be configured to: receive, from a base station, configuration information for configuring a radio link control (RLC) bearer for a first data set and a second data set; identify the first data set and the second data set included in one data radio bearer (DRB); allocate the first data set and the second data set to multiple RLC bearers, based on the configuration information; and transmit the first data set and the second data set through the multiple RLC bearers, and wherein the first data set and the second data set may have different QoS requirements.

The at least one processor may be configured to: receive, from the base station, a UECapabilityEnquiry message requesting information regarding whether a data set-based bearer configuration is supported; and transmit, to the base station, a UECapabilityInformation message including the information regarding whether a data set-based bearer configuration is supported.

The configuration information may include a first threshold for determining whether or not to operate a split bearer for the first data set and a second threshold for determining whether or not to operate a split bearer for the second data set. The at least one processor may be configured to: determine, based on the first threshold, at least one RLC bearer among the multiple RLC bearers as a first primary path and a first split secondary path for the first data set; determine, based on the second threshold, at least one RLC bearer among the multiple RLC bearers as a second primary path and a second split secondary path for the second data set; and allocate the first data set to the first primary path, and the first split secondary path, and allocate the second data set to the second primary path, and the second split secondary path.

The RLC bearers determined as the first primary path, the second split secondary path, the second primary path, and the second split secondary path may be different from each other.

The configuration information may include first duplication information regarding whether or not duplication is configured with regard to the first data set and second duplication information regarding whether or not duplication is configured with regard to the second data set.

The at least one processor may be configured to: determine, based on the first duplication information, at least one RLC bearer among the multiple RLC bearers as a first primary path and a first secondary path for the first data set; determine, based on the second duplication information, at least one RLC bearer among the multiple RLC bearers as a second primary path and a second secondary path for the second data set; and allocate the first data set to the first primary path, and the first secondary path; and allocate the second data set to the second primary path, and the second secondary path.

The RLC bearers determined as the first primary path, the second secondary path, the second primary path, and the second secondary path may be different from each other.

The at least one processor may be configured to identify the first data set and the second data set, based on identification information included in a header in a packet, or an internal interface of the terminal.

The at least one processor may be configured to: receive a MAC CE indicating activation or deactivation of a duplication function for at least one data set from among the first data set and the second data set; and based on the MAC CE, activate or deactivate a function of duplicating at least one data set from among the first data set and the second data set and transmitting the duplicated data set to multiple RLCs.

According to an embodiment of the disclosure, a base station of a wireless communication system may include: a transceiver; and at least one processor coupled to the transceiver, wherein the at least one processor may be configured to: transmit, to a terminal, configuration information for configuring a radio link control (RLC) bearer with regard to each of a first data set and a second data set; and receive the first data set and the second data set allocated to multiple RLC bearers, based on the configuration information, and wherein the first data set and the second data set may have different QoS requirements.

The at least one processor may be configured to: transmit, to the terminal, a UECapabilityEnquiry message requesting information regarding whether a data set-based bearer configuration is supported; and receive, from the terminal, a UECapabilityInformation message including the information regarding whether a data set-based bearer configuration is supported.

Advantageous Effects of Invention The disclosure provides a device and a method capable of effectively providing services in a wireless communication system.

### DESCRIPTION OF DRAWINGS

FIG. 1A illustrates a structure of a next-generation mobile communication system according to an embodiment of the disclosure.

FIG. 1B illustrates a radio protocol structure of long term evolution (LTE) and new radio (NR) systems according to an embodiment of the disclosure.

FIG. 1C illustrates an application data unit (ADU)-based protocol data unit (PDU) set configuration according to an embodiment of the disclosure.

FIG. 1D illustrates a split bearer configuration according to an embodiment of the disclosure.

FIG. 1E illustrates an example of a packet transmission operation when a split bearer operation is configured with regard to each data radio bearer (DRB) according to an embodiment of the disclosure.

FIG. 1F illustrates an example of a packet transmission operation when a split bearer operation is configured with regard to each set according to an embodiment of the disclosure.

FIG. 1G illustrates an example of a set-based split bearer operation configuration according to an embodiment of the disclosure.

FIG. 1H illustrates a procedure of signaling between a UE and a gNB in order to configure and operate split bearers with regard to respective sets in a next-generation mobile communication system according to an embodiment of the disclosure.

FIG. 1I illustrates a media access control element (MAC CE) structure that can be used to activate/deactivate PDCP duplication with regard to respective sets according to an embodiment of the disclosure.

FIG. 1J illustrates a UE device according to an embodiment of the disclosure.

FIG. 1K illustrates a gNB device according to an embodiment of the disclosure.

### MODE FOR THE INVENTION

Hereinafter, embodiments of the disclosure will be described in detail with reference to the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification. Hereinafter, embodiments of the disclosure will be described with reference to the accompanying drawings.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, the terms “physical channel” and “signal” may be interchangeably used with the term “data” or “control signal”. For example, the term “physical downlink shared channel (PDSCH)” refers to a physical channel over which data is transmitted, but the PDSCH may also be used to refer to the “data”. That is, in the disclosure, the expression “transmit ting a physical channel” may be construed as having the same meaning as the expression “transmitting data or a signal over a physical channel”.

In the following description of the disclosure, upper signaling refers to a signal transfer scheme from a base station to a terminal via a downlink data channel of a physical layer, or from a terminal to a base station via an uplink data channel of a physical layer. The upper signaling may also be understood as radio resource control (RRC) signaling or a media access control (MAC) control element (CE).

In the following description of the disclosure, terms and names defined in the 3rd generation partnership project new radio (3GPP NR) or 3GPP long term evolution (3GPP LTE) standards will be used for the sake of descriptive convenience. However, the disclosure is not limited by these terms and names, and may be applied in the same way to systems that conform other standards. In the disclosure, the term “g NB” may be interchangeably used with the term “e NB” for the sake of descriptive convenience. That is, a base station described as “eNB” may refer to “gNB”. Furthermore, the term “terminal” may refer to not only a mobile phone, an MTC device, an NB-IoT device, and a sensor, but also other wireless communication devices.

In the following description, a base station is an entity that allocates resources to terminals, and may be at least one of a gNode B (gNB), an eNode B (eNB), a Node B, a base station (BS), a wireless access unit, a base station controller, and a node on a network. The terminal may include a user equipment (UE), a mobile station (MS), a cellular phone, a smartphone, a computer, or a multimedia system capable of performing a communication function. Of course, the examples given above are not limiting.

In particular, the disclosure may be applied to 3GPP NR (5th generation mobile communication standard). In addition, the disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology. In the disclosure, the term “eNB” may be interchangeably used with the term “gNB” for the sake of descriptive convenience. That is, a base station described as “eNB” may refer to “gNB”. In addition, the term “terminal” may refer to not only mobile phones, NB-IoT devices, and sensors, but also any other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, eMBB may aim at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHZ or more, instead of transmitting signals using a transmission bandwidth up to 20 MHz in a band of 2 GHz used in LTE.

In addition, mMTC is being considered to support application services such as the Internet of Things (IOT) in the 5G communication system. mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also require a packet error rate of 10-5 or less. Therefore, for the services supporting URLLC, a 5G system must provide a transmit time interval (TTI) shorter than those of other services, and may also require a design for assigning a large number of resources in a frequency band in order to secure reliability of a communication link.

The above described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, mMTC, URLLC, and eMBB as described above are merely an example of different types of services, and service types to which the disclosure is applied are not limited to those mentioned above.

In the following description of embodiments of the disclosure, LTE, LTE-A, LTE Pro, or 5G (or NR, next-generation mobile communication) systems will be described by way of example, but the embodiments of the disclosure may be applied to other communication systems having similar backgrounds or channel types. In addition, based on determinations by those skilled in the art, the embodiments of the disclosure may be applied to other communication systems through some modifications without significantly departing from the scope of the disclosure.

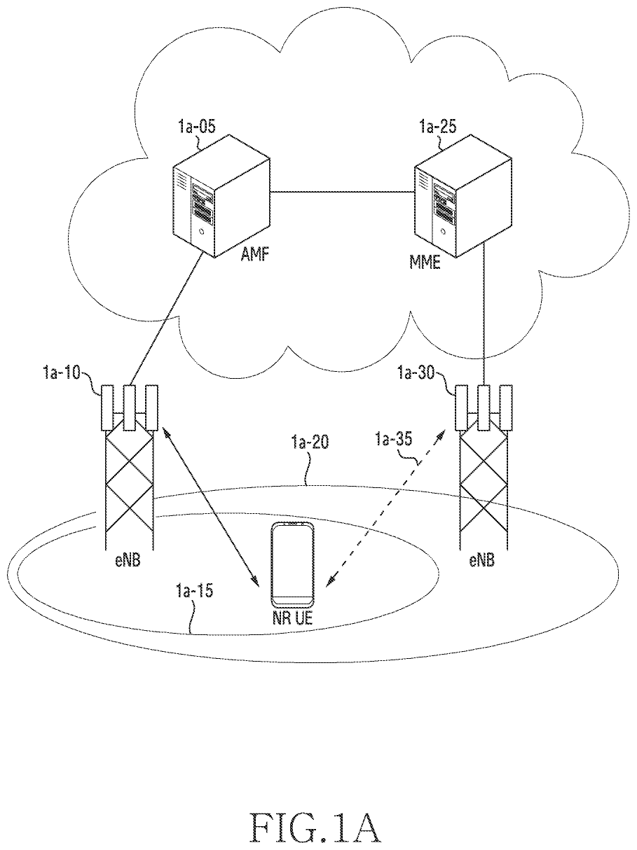

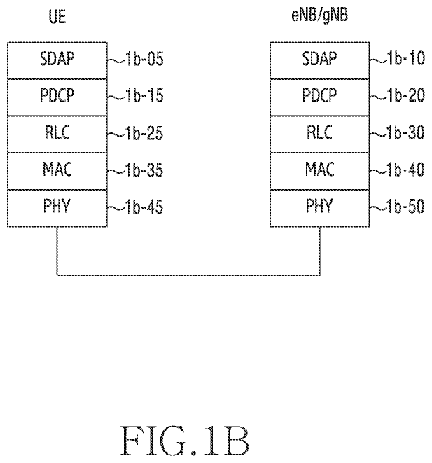

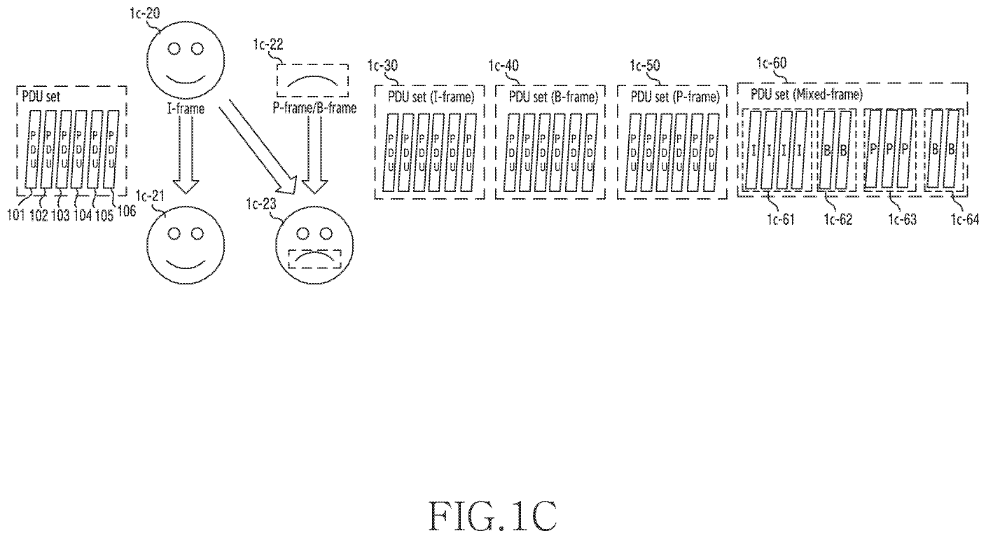

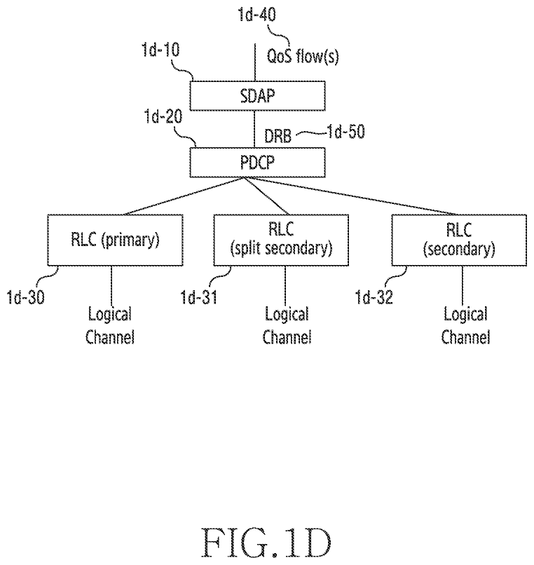

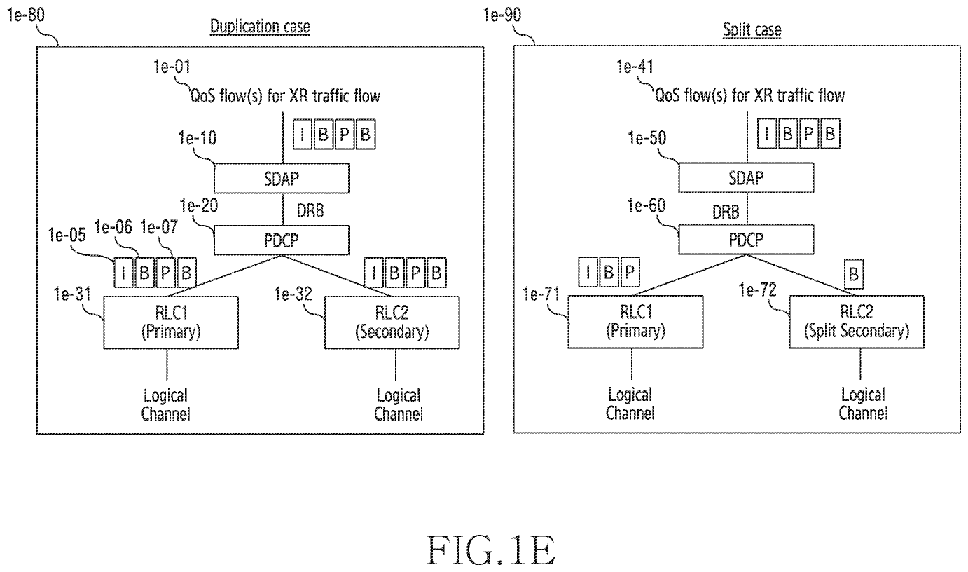

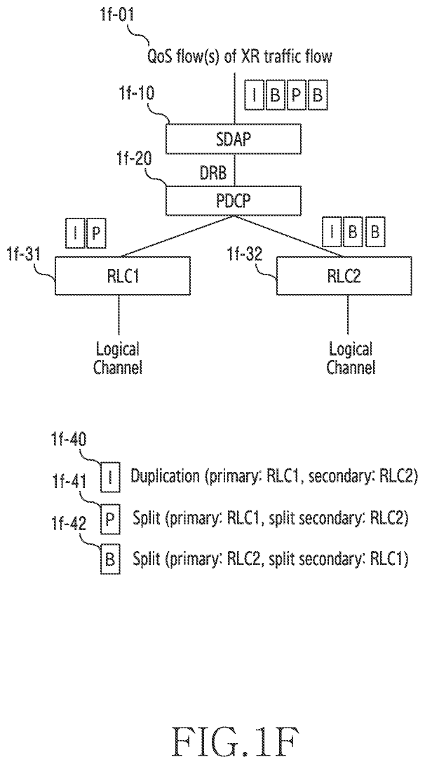

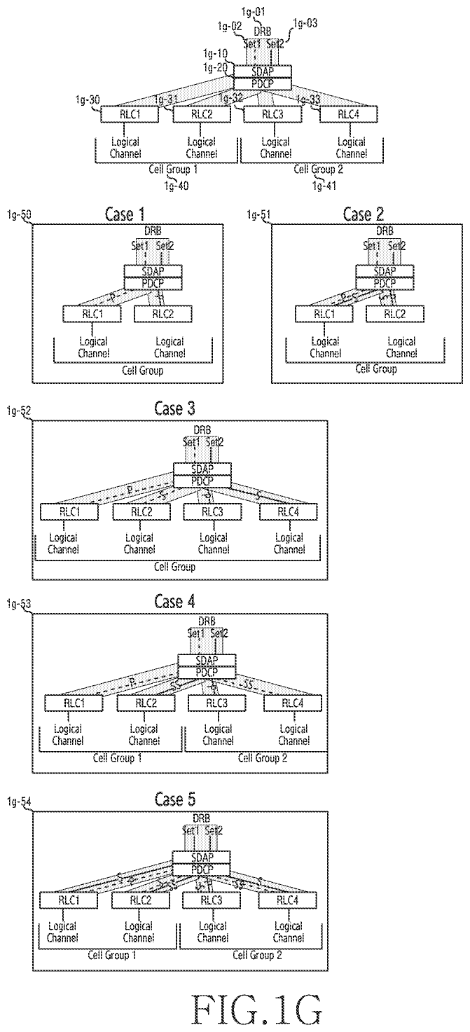

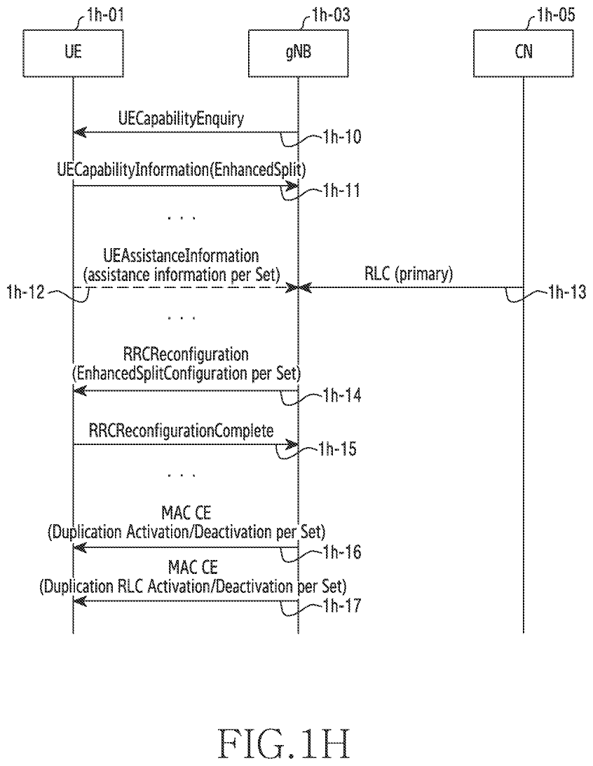

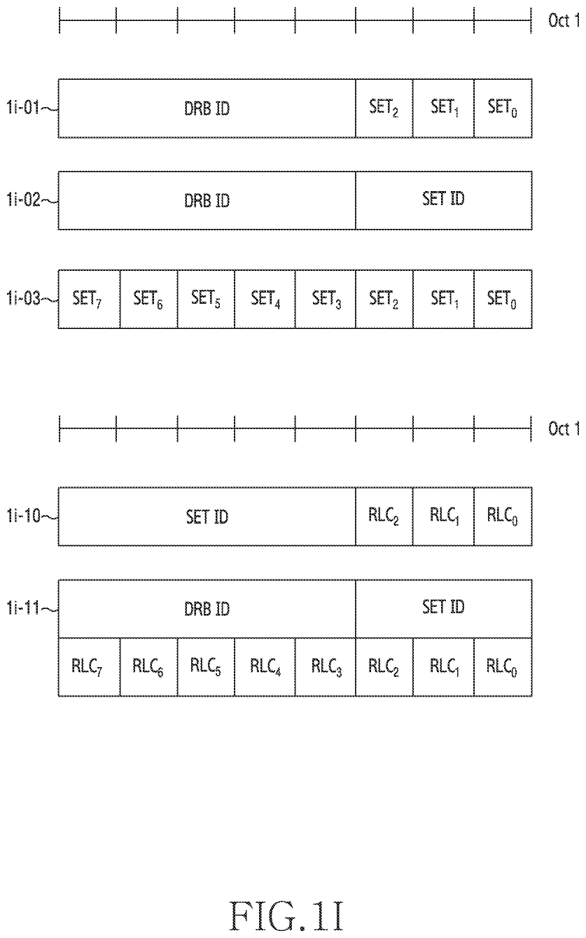

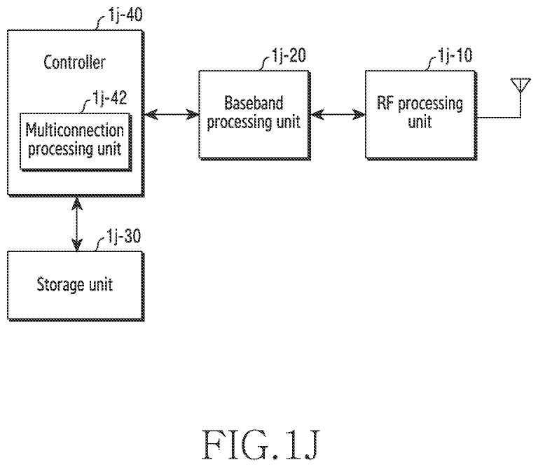

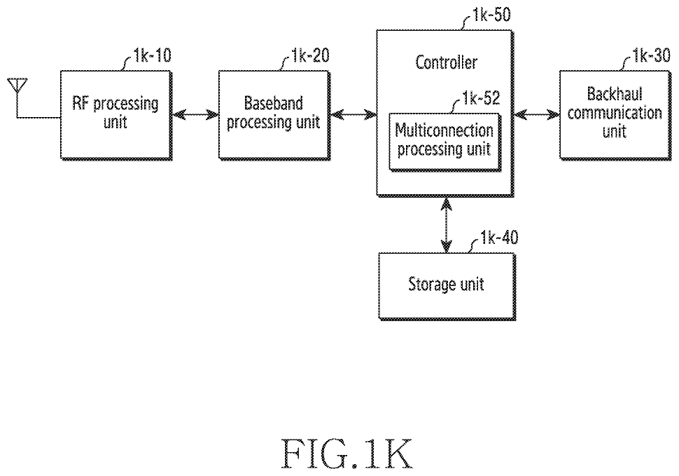

Referring to FIG. 1A, as illustrated therein, a radio access network of a wireless communication system (hereinafter, next-generation mobile communication system (new radio, NR or 5G)) includes a next-generation base station (new radio node B, hereinafter gNB) 1a-10 and an access and mobility management entity (AMF, new radio core network) 1a-05. A user equipment (new radio user equipment, hereinafter NR UE or NR terminal) 1a-15 accesses an external network via the gNB 1a-10 and the AMF 1a-05.

In FIG. 1A, the gNB 1a-10 corresponds to an evolved node B (eNB) 1a-30 of a conventional LTE system. The gNB 1a-10 may be connected to the NR UE 1a-15 through a radio channel and provide outstanding services as compared to a conventional node B (1a-20).

According to an embodiment of the disclosure, in the next-generation mobile communication system, since all user traffic is serviced through a shared channel, a device that collects state information, such as buffer statuses, available transmit power states, and channel states of UEs, and performs scheduling accordingly is required, and the gNB 1a-10 serves as the device. In general, one gNB may control multiple cells.

According to an embodiment of the disclosure, in order to implement ultrahigh-speed data transfer beyond the current LTE, the next-generation mobile communication system may provide a wider bandwidth than the existing maximum bandwidth, may employ an orthogonal frequency division multiplexing (hereinafter referred to as OFDM) as a radio access technology, and may additionally integrate a beamforming technology therewith.

Furthermore, according to an embodiment of the disclosure, the next-generation mobile communication system may employ an adaptive modulation & coding (hereinafter referred to as AMC) scheme for determining a modulation scheme and a channel coding rate according to a channel state of a UE. The AMF 1a-05 may perform functions such as mobility support, bearer configuration, and QoS configuration. The AMF is a device responsible for various control functions as well as a mobility management function for a UE, and may be connected to multiple base stations. In addition, the next-generation mobile communication system may interwork with the existing LTE system, and the AMF 1a-05 is connected to an MME 1a-25 via a network interface. The MME 1a-25 is connected to an eNB 1a-30 that is an existing base station. A UE supporting LTE-NR dual connectivity may transmit/receive data while maintaining connections to both the gNB 1a-10 and the eNB 1a-30.

FIG. 1B illustrates a radio protocol structure of LTE and NR systems according to an embodiment of the disclosure.

Referring to FIG. 1B, a radio protocol of an NR system may include an NR service data adaptation protocol (SDAP) 1b-05 or 1b-10, an NR packet data convergence protocol (PDCP) 1b-15 or 1b-20, an NR radio link control (RLC) 1b-25 or 1b-30, and an NR medium access controls (MAC) 1b-35 or 1b-40 on each of UE and NR base station sides. The SDAP 1b-05 or 1b-10 may perform an operation for mapping each QoS flow to a specific data radio bearer (DRB), and the SDAP configuration corresponding to each DRB may be given from the upper layer (for example, RRC layer).

According to an embodiment of the disclosure, the PDCP 1b-15 or 1b-20 may be responsible for operations such as IP header compression and/or restoration, and the RLC 1b-25 or 1b-30 may reconstruct a PDCP PDU into an appropriate size. The MAC 1b-35 or 1b-40 may be connected to several RLC layer devices configured for a single UE, and perform operations of multiplexing RLC PDUs into an MAC PDU and demultiplexing an MAC PDU into RLC PDUs. A physical (PHY) layer 1b-45 or 1b-50 may perform operations of channel-coding and modulating upper layer data, producing an orthogonal frequency-division multiplexing (OFDM) symbol therefrom and transmitting the same through a radio channel, or demodulating an OFDM symbol received through the radio channel, channel-decoding the same, and delivering the same to the upper layer.

In addition, according to an embodiment of the disclosure, the PHY layer 1b45 or 1b-50 may use a hybrid automatic repeat request (HARQ) for additional error correction, and the receiving end may transmit one bit to the transmitting end to indicate whether a packet transmitted thereby has been received. Information regarding whether the receiving end has received a packet from the transmitting end may be referred to as HARQ ACK/NACK information. In the case of an LTE system, downlink HARQ ACK/NACK information regarding uplink data transmission may be transmitted through a physical HARQ indicator channel (PHICH). In the case of an NR system, downlink HARQ ACK/NACK information regarding uplink data transmission may be transmitted through a physical dedicated control channel (PDCCH), which is used to transmit a downlink and/or uplink resource allocation or the like, and the base station may determine, based on the UE's scheduling information, whether retransmission is necessary or new transmission is to be performed.

The reason the base station in an NR system determines, based on the UE's scheduling information, whether retransmission is necessary or new transmission is to be performed, unlike LTE, is because an asynchronous HARQ is applied in the NR. Uplink HARQ ACK/NACK information regarding downlink data transmission may be transmitted through a physical uplink control channel (PUCCH) or through a physical uplink shared channel (PUSCH). The PUCCH may be generally transmitted in the uplink of the primary cell (PCell) (described later). However, in case that the UE supports the same, HARQ ACK/NACK information regarding the secondary cell (SCell) (described later) may be transmitted, and the SCell may be referred to as a PUCCH SCell.

Although not illustrated in the drawing, a radio resource control (RRC) layer may exist on each upper layer of the PDCP layer of the UE and the base station, and the RRC layer may exchange access/measurement-related configuration control messages for radio resource control.

The PHY layer 1b-45 or 1b-50 may include one or multiple frequencies/carriers, and a technology for simultaneously configuring and using multiple frequencies may be referred to as carrier aggregation (hereinafter CA). The CA technology refers to a technology for, instead of using only one carrier for communication between a UE and a base station (for example, eNB or gNB), additionally using a main carrier and one or multiple subcarriers to increase the amount of transmission as much as the number of subcarriers. Meanwhile, a cell in a base station, which uses the main carrier in LTE and NR systems, may be referred to as a primary cell or PCell, and a cell in a base station, which uses the subcarriers, may be referred to as a secondary cell or SCell.

FIG. 1C illustrates an application data unit (ADU)-based PDU set configuration according to an embodiment of the disclosure.

Referring to FIG. 1C, various kinds of traffic may be distinguished by ADUs which are units of information distinguishable at the application level. According to an embodiment, an ADU may be one photograph or picture, one frame of video data, or one unit of audio data. Each ADU may be distinguished by a PDU set 1c-10, and the PDU set 1c-10 may be divided into one or more PDUs 1c-01, 1c-02, 1c-03, 1c-04, 1c-05, and 1c-06 according to the size and then transmitted.

For example, in case that moving picture experts group (MPEG) standard video compression technology is used in connection with video traffic, a PDU set may be configured by one of 1) a combination 1c-30 of multiple PDUs corresponding to one intra (I)-frame, 2) a combination 1c-40 of multiple PDUs corresponding to one bidirectional (B)-frame, 3) a combination 1c-50 of multiple PDUs corresponding to one predicted (P)-frame, and 4) a combination 1c-60 of multiple PDUs corresponding to an ADU configured by multiple I-frames 1c-61, B-frames 1c-62 and 1c-64, and/or P-frames 1c-63.

According to an embodiment of the disclosure, the I-frame 1c-20 is an independent frame and may represent a whole photograph or picture 1c-21 regardless of whether other frames exist or not. The P-frame and B-frame 1c-22 indicate information regarding a change in the previous I-frame 20. If the I-frame 20 has not been received normally, it may be difficult to normally express the photograph or picture intended to be expressed by the P-frame and B-frame 1c-22. In addition, the B-frame is between the I-frame and P-frame and references both frames such that the same is stored as data that estimates movements between the two frames. Therefore, the photograph or picture intended to be expressed by the B-frame may be expressed normally only if not only the preceding I-frame, but also the following P-frame are normally received.

In an embodiment of the disclosure, for convenience of description, the configuration of a PDU set and a PDU set discarding (or ADU discarding) operation may be described with reference to an example in which MPEG standard video compression technology is used in connection with video traffic. However, the content of the disclosure is not limited to the PDU set configuration in connection with video traffic, and may be applied to all PDU set configurations configured by normal ADU units.

According to an embodiment of the disclosure, an XR traffic flow for a specific extended reality (XR) service may be configured by a combination of pieces of data (for example, PDUs, PDU sets, and the like) having different quality of service (QoS) requirements. For example, when video traffic coded by MPEG for a specific XR service is transmitted, various kinds of PDU sets having different QoS requirements (for example, delay, reliability, and the like) corresponding to I-frame/B-frame/P-frame may constitute one XR traffic flow.

According to an embodiment of the disclosure, in order to service an XR traffic flow configured by pieces of data having various QoS requirements, the network may map the XR traffic flow to one or more QoS flows. Alternatively, the network may map the XR traffic flow to one QoS flow and then define one or more sub-flows in the QoS flow again such that pieces of data having different QoS requirements are mapped with regard to each sub-flow. In case that one or more QoS flows (or QoS sub-flows) are used to service a specific XR traffic flow as described above, pieces of data constituting the same XR traffic flow may be delivered through different QoS flows (or QoS sub-flows) according to the QoS requirements. Different QoS flows (or QoS sub-flows) may again be mapped to different DRBs or mapped to the same DRB.

FIG. 1D illustrates a split bearer configuration according to an embodiment of the disclosure. The SDAP 1d-10 layer may map each QoS flow 1d-40 to a specific DRB. In case that one or more QoS flows exist, multiple QoS flows may be mapped to one DRB. According to an embodiment of the disclosure, the split bearer may be a DRB 1d-50 that transmits data by using two or more RLC bearers (or RLC entities) 1d-30, 1d-31, and 1d-32. In a dual connectivity scenario, RLC entities configured for different cell groups may be mapped together to the same split bearer. In addition, each RLC entity may again be mapped to each logical channel. When data is transmitted through a split bearer, multiple RLC bearers may be used in the following two methods. Obviously, the following example is not limitative.
1) Duplication operation: in order to increase the reliability and safety during packet transmission, the same packet is transmitted redundantly on the PDCP layer through different RLC entities.
2) Split operation: in order to increase the data rate during packet transmission, a packet is transmitted on the PDCP layer through one of different RLC entities.

According to an embodiment of the disclosure, when a UE transmits uplink (UL) data through a split bearer, the PDCP entity 1d-20 may interwork with multiple RLC entities 1d-30, 1d-31, and 1d-32 and perform duplication and split operations according to RRC configurations.

According to an embodiment of the disclosure, one primary path (or primacy RLC entity) 1d-30 may be configured for each split bearer. In case that both the duplication operation and the split operation are not activated, packets may be transmitted by using the primary path 1d-30. For the split operation, one split secondary path (or split secondary RLC entity) 1d-31 and ul-DataSplitThreshold may be configured for each split bearer. In case that the split bearer's split operation condition is satisfied (for example, in case that the duplication operation has not been activated with regard to the corresponding split bearer, and the total amount of data that stands by on the PDCP and RLC layers to be transmitted by using the primary RLC entity and split secondary RLC entity is larger than or equal to ul-DataSplitThreshold), the PDCP layer may deliver a packet (PDCP PDU) by using one of the primary RLC entity 1d-30 or the split secondary RLC entity 1d-31.

According to an embodiment of the disclosure, the split operation may be allowed only in case that RLC entities configured for different cell groups are mapped to a split bearer in the dual connectivity scenario. In this case, the split secondary RLC entity may be configured as an RLC entity configured in a cell group other than the cell group for which the primary RLC entity is configured. For the duplication operation, one or more secondary paths (or secondary RLC entities) 1d-32 may be configured for each split bearer. The secondary path 1d-32 may be explicitly configured through RRC or MAC signaling, or RLC entities other than the primary path, among RLC entities mapped to the corresponding split bearer, may all be deemed (or considered) to be secondary RLC entities 1d-32 without explicit configurations.

According to an embodiment of the disclosure, the split bearer's duplication operation may be activated and deactivated with regard to each DRB through RRC and MAC layer signaling. In case that the split bearer's duplication operation is activated, the PDCP layer may redundantly transmit the same packet (PDCP PDU) through the primary RLC entity 1d-30 and one or more secondary RLC entities 1d-32.

FIG. 1E illustrates an XR traffic transmission operation through a split bearer in case that a split bearer operation is configured with regard to each DRB. In this embodiment, the XR traffic flow may be configured by a combination of pieces of data (for example, in the case of video traffic, PDUs or PDU sets corresponding to the I-frame 1e-05, B-frame 1e-06, and P-frame 1e-07, respectively) having different QoS requirements (for example, delay/reliability-related requirements) as described above with reference to FIG. 1C. In addition, pieces of data included in the same XR traffic flow may be mapped to one or more QoS flows (or QoS sub-flows) 1e-01 and 1e-41 and delivered to the SDAP layers 1e-10 and 1e-50. The SDAP layers may map multiple QOS flows (or QoS sub-flows) mapped to the same XR traffic flow to the same DRB. The DRB may be configured as a split bearer that transmits data through multiple RLC bearers in order to process XR traffic flows having different QoS requirements.

According to an embodiment of the disclosure, as described above with reference to FIG. 1D, configurations (primary path, secondary path, split secondary path, ul-DataSplitThreshold, duplication operation activation/deactivation state, and the like) regarding the split bearer's split and duplication operations may be configured with regard to each DRB. Therefore, all packets transmitted through the split bearer may be transmitted according to the same split bearer operation configuration. In addition, although embodiments of the disclosure assume, for convenience of description, that an XR traffic flow is configured by video traffic flows (for example, PDUs or PDU sets corresponding to an I-frame, a B-frame, and a P-frame, respectively) having different QOS requirements, the same descriptions are applicable to normal XR traffic flows (for example, in case that XR traffic flows do not have different QoS requirements, or in the case of a type of traffic other than video traffic).

According to an embodiment of the disclosure, pieces of data (for example, PDUs or PDU sets) corresponding to the I-frame 1e-05, B-frame 1e-06, and P-frame 1e-07 included in the same XR traffic flow, respectively, may have different QoS requirements, and may be delivered to the SDAP layers 1e-10 and 1e-20 through one or multiple QOS flows (or QoS sub-flows) 1e-01 and 1e-41. The SDAP layers 1e-10 and 1e-20 may map multiple QoS flows (or QoS sub-flows) mapped to the same XR traffic flow to the DRB configured as the split bearer.

In case 1e-80 that the split bearer is configured to perform a duplication operation as in the embodiment in FIG. 1D, the PDCP layer 1e-20 may perform the duplication operation with regard to all packets through the primary path 1e-31 and the secondary path le-32 configured with regard to each DRB, without distinguishing packets (PDCP SDUs) corresponding to the I-frame 1e-05, B-frame 1e-06, and P-frame 1e-07, respectively.

Meanwhile, in case 1e-90 that the split bearer is configured to perform a split operation as in the embodiment in FIG. 1D, the PDCP layer 1e-60 may perform the split operation according to split operation configurations (for example, the primary path 1e-71, the split secondary path 1e-72, ul-DataSplitThreshold, and the like) configured with regard to each DRB, without distinguishing packets (PDCP SDUs) corresponding to the I-frame 1e-05, B-frame 1e-06, and P-frame 1e-07, respectively. As described above, in case that a split bearer operation configuration is performed with regard to each DRB, the same duplication 1e-80 and split 1e-90 operations are performed with regard to all pieces of data transmitted through the corresponding DRB. Therefore, in case that XR traffic flows have different QoS requirements, there may be restrictions on performing the duplication and split operations according to each packet's QoS requirements.

FIG. 1F illustrates an example of a packet transmission operation when a split bearer operation is configured with regard to each set according to an embodiment of the disclosure. That is, FIG. 1F illustrates an XR traffic transmission operation through a split bearer when a split bearer operation is configured with regard to each set. According to an embodiment of the disclosure, as described above with reference to FIG. 1C, the XR traffic flow may be configured by a combination of pieces of data (for example, in the case of video traffic, PDUs or PDU sets corresponding to the I-frame 1f-40, P-frame 1f-41, and B-frame 1f-42, respectively) having different QoS requirements (for example, delay/reliability-related requirements). Although it is assumed in this embodiment, for convenience of description, that the XR traffic flow is configured by video traffic flows (for example, PDUs or PDU sets corresponding to an I-frame, a B-frame, and a P-frame, respectively) having different QoS requirements, the same descriptions are applicable to normal XR traffic flows (for example, in case that XR traffic flows do not have different QoS requirements, or in the case of a type of traffic other than video traffic). Pieces of data included in the same XR traffic flow may be mapped to one or more QoS flows (or QoS sub-flows) 14-01 and delivered to the SDAP layer 1f-10. The SDAP layer 1f-10 may map multiple QoS flows (or QoS sub-flows) mapped to the same XR traffic flow to the same DRB. The DRB may be configured as a split bearer that transmits data through multiple RLC bearers in order to process XR traffic flows having different QoS requirements.

In this embodiment, as described above with reference to FIG. 1D, configurations (primary path, secondary path, split secondary path, ul-DataSplitThreshold, duplication operation activation/deactivation state, and the like) regarding the split bearer's split and duplication operations may be configured with regard to each “set”.

As used herein, a “set” may refer to a combination of pieces of data having identical or similar QoS requirements, and the “set” may be used as a new unit for split bearer operation configurations. Specifically, the “set” may be a QoS flow (or sub-QoS flow), a PDU set, a combination of PDU sets (for example, multiple PDU sets), a combination of PDUs (for example, multiple PDUs), and the like, and is not limited to the above examples. In other words, a set may be a data unit having a predetermined size used to configure split bearer operations, and distinction of the set may be determined according to predetermined conditions. For example, pieces of data belonging to the same set may have identical or similar QoS requirements. Obviously, distinction of the set is not determined only by QoS requirements, and may be based on the data type or the source of data (for example, applications or flows). In the disclosure, “set” may be used interchangeably with various terms, such as a split configuration data set, a QoS configuration data set, and a duplicate configuration data set.

Therefore, even packets (for example, PDCP SDUs) delivered through the same split bearer may be transmitted according to different split bearer operation configurations according to which set they belongs to, and thus may have different levels of guaranteed QoS.

Embodiments of the disclosure describe operations in case that a split bearer operation is configured with regard to each PDU set (in case that a set corresponds to a PDU set). For example, with regard to a PDU set corresponding to the I-frame 1f-40, a duplication operation may be configured to guarantee a high level of reliability. Therefore, when transmitting a PDU set corresponding to the I-frame, the PDCP layer 1f-20 may redundantly transmit the same packet through the primary RLC entity 1f-31 and the second RLC entity 1f-32. With regard to the PDU set corresponding to the P-frame 1f-41 and the B-frame 1f-42, a split operation may be configured to increase the data transmission rate.

However, in case that the P-frame 1f-41 and the B-frame 1f-42 have different QoS requirements (delay, reliability, and the like) and traffic characteristics (packet generating cycle, packet size, and the like), RLC/MAC configurations appropriate for transmission of PDU sets corresponding to respective frame types may differ, and different primary RLC entities and split secondary RLC entities may be configured with respective PDU sets corresponding to respective frames. This embodiment illustrates an example in which, with regard to the PDU set corresponding to the P-frame 1f-41, RLC1 1f-31 is configured as the primary path, and RLC2 1f-32 is configured as the split secondary path, and with regard to the PDU set corresponding to the B-frame 1f-42, RLC2 1f-32 is configured as the primary path, and RLC1 1f-31 is configured as the split secondary path.

FIG. 1G illustrates set-based split bearer operation configurations according to an embodiment of the disclosure. The SDAP 1g-10 layer may map one or more QoS flows (or QoS sub-flows) to the same DRB 1g-01. The DRB may be configured as a split bearer that transmits data by using two or more RLC bearers (or RLC entities) 1g-30, 1g-31, 1g-32, and 1g-33 in order to process data packets having different QoS requirements.

In embodiments of the disclosure, when the UE transmit UL data through a split bearer as described above with reference to FIG. 1D, configurations (primary path, secondary path, split secondary path, ul-DataSplitThreshold, duplication operation activation/deactivation state, and the like) for split and duplication operations on the PDCP layer 1g-20 may be configured with regard to each “set”. In addition, split and duplication configurations may be provided from the gNB through RRC signaling.

According to an embodiment of the disclosure, a “set” may refer to a combination of pieces of data having similar QoS requirements, and may be used as a unit of split bearer operation configurations.

Specifically, the “set” may be a QoS flow (or sub-QoS flow), a PDU set, a combination of PDU sets, a combination of PDUs, and the like, and is not limited to the above examples. (The correspondence between the QoS flow or PDU set or PDU and the “set” may be provided through RRC signaling.) Therefore, even packets (for example, PDCP SDUs) delivered through the same split bearer may be transmitted according to different split bearer operation configurations according to which set they belongs to, and thus may have different levels of guaranteed QoS.

According to an embodiment of the disclosure, as in FIG. 1G, the DRB 1g-01 may be configured as a split bearer that may transmit data through multiple RLC bearers 1g-30, 1g-31, 1g-32, and 1g-33. In a dual connectivity scenario, the RLC bearers 1g-30, 1g-31, 1g-32, and 1g-33 may be configured in different cell groups 1g-40 and 1g-41. Pieces of data transmitted through the DRB 1g-01 may be distinguished as one or more sets 1g-02 and 1g-03 according to QoS requirements (for example, requirements regarding delay and reliability) and traffic characteristics (for example, characteristics regarding the cycle and data size).

According to an embodiment of the disclosure, when the SDAP layer 1g-10 delivers packets (SDAP PDUs or PDCP SDUs) to be transmitted through the DRB 1g-01 to the PDCP layer 1g-20, the SDAP layer 1g-10 may include a value corresponding to the set ID in each packet's SDAP header in order to indicate to which set each packet belongs to. Alternatively, an interface inside the UE may be used to indicate, to the PDCP layer 1g-20, to which set each packet belongs to. In case that information regarding to which set a specific packet belongs to is not indicated to the PDCP layer, the PDCP layer may determine that the corresponding packet does not belong to a specific set and may perform transmission according to split bearer operation configurations configured with regard to each DRB. Therefore, set-based split bearer operation configurations and DRB-based split bearer operations may be configured together, and according to whether each packet belongs to a specific set or does not belong to any set, the PDCP layer may determine split bearer operation configurations to be used to transmit the corresponding packet.

According to an embodiment of the disclosure, when transmitting a UL packet, the UE's PDCP layer 1g-20 may perform a split or duplication operation according to split bearer operation configurations given through RRC or MAC signaling with regard to the set to which the packet belongs. Specifically, the following parameters may be separately configured in relation to split bearer operations with regard to each set.
Primary path: the primary RLC entity's logical channel ID (LCID) and cell group ID values.
Split secondary path: the split secondary RLC entity's LCID value. In case that no split operation is necessary, no split secondary path may be configured. Even in case that a split operation is necessary, and in case that two RLC entities are mapped to a DRB, an RLC entity other than the primary RLC entity may be the split secondary path without explicit secondary path configurations.
Secondary path: the secondary path RLC entity's LCID value. In case that multiple secondary paths exist, multiple LCID values may be configured. In case that the duplication operation is deactivated, no secondary path may be configured. In case that the duplication operation is activated, and in case that no secondary path may be configured explicitly, all RLC entities other than the primary RLC entity among RLC entities mapped to the corresponding DRB may be regarded as being configured as secondary paths.
ul-DataSplitThreshold: a threshold value used during a split operation. The split operation may be activated only in case that the total amount of data that stands by on the PDCP and RLC layers to be transmitted by using the primary RLC entity and split secondary RLC entity is larger than or equal to ul-DataSplitThreshold (in case that this value is configured with regard to each set, the total amount of data that stands by may be individually calculated with regard to each set). In case that this value is configured to be infinite, packets may be transmitted only through the primary path.
pdcp-Duplication (or duplicationState): a parameter that indicates the state of activation of the duplication operation. The corresponding value, if configured to be “true”, may indicate that duplication is activated. In case that two or more secondary RLC entities are configured, whether the duplication operation is activated or not may be individually indicated with regard to each secondary RLC entity.

In the disclosure, various cases in which a split bearer operation is configured with regard to each set will be described through the following embodiments for convenience of description, but configuring a split bearer operation with regard to each set is not limited to the following embodiments. It will be assumed in the following embodiments that multiple data sets (Set1 and Set2) are transmitted through one DRB. Respective sets may have different QoS requirements, and a separate split bearer operation may be configured with regard to each set.

Case 1 (1g-50): different primary paths may be configured with regard to respective sets. RLC1 may be configured as the primary path of Set 1, and RLC2 may be configured as the primary path of Set 2. In case that duplication and split operations are not necessary with regard to the corresponding set, the secondary path and the split secondary path may not be configured.

Case 2 (1g-51): different primary paths and secondary paths may be configured for the duplication operation with regard to respective sets. RLC1 may be configured as the primary path of Set 1, RLC2 may be configured as the secondary path of Set 1, RLC2 may be configured as the primary path of Set 2, and RLC1 may be configured as the secondary path of Set 2. In order to activate and deactivate the duplication operation with regard to respective sets, the PDCP duplication state may be configured through RRC signaling with regard to respective sets, and a MAC CE that indicates the PDCP duplication state may be delivered through MAC CE signaling. In case that no split operation is necessary with regard to a set, no split secondary path may be configured. In this case, if the duplication operation is deactivated with regard to a specific set, all packets corresponding to the set may be transmitted through the primary path.

Case 3 (1g-52): different sets may be configured to use different RLC entities. Different primary paths and secondary paths may be configured for the duplication operation with regard to respective sets. RLC1 may be configured as the primary path of Set 1, RLC2 may be configured as the secondary path of Set 1, RLC3 may be configured as the primary path of Set 2, and RLC4 may be configured as the secondary path of Set 2. In order to activate and deactivate the duplication operation with regard to respective sets, the PDCP duplication state may be configured through RRC signaling with regard to respective sets, and a MAC CE that indicates the PDCP duplication state may be delivered through MAC CE signaling. In case that no split operation is necessary with regard to a set, no split secondary path may be configured. In this case, if the duplication operation is deactivated with regard to a specific set, all packets corresponding to the set may be transmitted through the primary path. Although it has been assumed in the above embodiment that different sets do not share the same RLC entity, different sets may share some of the RLC entities that are mapped to the split bearer. (That is, different sets may be transmitted together through some RLC entities.)

Case 4 (1g-53): different sets may be configured to use different RLC entities. Different primary paths and secondary paths may be configured for the split operation with regard to respective sets. RLC1 may be configured as the primary path of Set 1, RLC4 may be configured as the secondary path of Set 1, RLC3 may be configured as the primary path of Set 2, and RLC2 may be configured as the secondary path of Set 2. The split operation may be performed with regard to respective sets, and the value of ul-DataSplitThreshold which is used for the split operation to this end may also be configured with regard to respective sets. In case that no duplication operation is necessary, no secondary path may be configured. Although it has been assumed in the above embodiment that different sets do not share the same RLC entity, different sets may share some of the RLC entities that are mapped to the corresponding split bearer. (That is, different sets may be transmitted together through some RLC entities.)

Case 5 (1g-54): different primary paths, split secondary paths, and secondary paths may be configured for the duplication and split operations with regard to respective sets. RLC1 may be configured as the primary path of Set 1, RLC4 may be configured as the split secondary path of Set 1, RLC2 and RLC3 may be configured as the secondary paths of Set 1, RLC3 may be configured as the primary path of Set 2, RLC2 may be configured as the split secondary path of Set 2, RLC1 and RLC4 may be configured as the secondary paths of Set 2. The split operation may be performed with regard to respective sets, and the value of ul-DataSplitThreshold which is used for the split operation to this end may also be configured with regard to respective sets. In addition, in order to activate and deactivate the duplication operation with regard to respective sets, the PDCP duplication state may be configured through RRC signaling with regard to respective sets, and a MAC CE that indicates the PDCP duplication state may be delivered through MAC CE signaling.

FIG. 1H illustrates a procedure of signaling between a UE 1h-01 and a gNB 1h-03 in order to configure and operate split bearers with regard to respective sets. With regard to respective steps, the procedure is as follows.

UECapabilityEnquiry (gNB->UE) (1h-10): the gNB 1h-03 may deliver a UECapability Enquiry message to the UE 1h-01 in a connected state to request a capability report. According to an embodiment, the gNB 1h-03 may have a capability report request included in the UECapability Enquiry message with regard to each radio access technology (RAT) type. The request with regard to each RAT type may include requested frequency band information. In addition, according to an embodiment of the disclosure, when the gNB 1h-03 requests the UE 1h-01 to generate a UECapability Information message, filtering information may be included therein such that conditions and restrictions can be indicated. Through the filtering information, the gNB 1h-03 may indicate whether or not the UE 1h-01 has to report capability regarding set-based split bearer operations and configurations. Obviously, the above example is not limitative, and the filtering information may or may not be included in the UECapability Information message.

UECapabilityInformation (UE->gNB) (1h-11): the UE 1h-01 may transmit a message including UECapability Information to the gNB 1h-03 in response to the UECapabilityEnquiry message 1h-10. UECapabilityInformation may be a response to UECapability Enquiry. According to an embodiment of the disclosure, the UECapability Information message may include a parameter indicating whether the UE 1h-01 supports set-based split bearer operations and configurations. The gNB 1h-03 may determine, based on the received UECapability Information message, whether or not the UE 1h-01 supports set-based split bearer operations and configurations.

UEAssistanceInformation (UE->gNB) (1h-12): the UE 1h-01 may deliver, to the gNB, aUEAssistanceInformation message including assistance information needed by the gNB 1h-03 to configure split bearer operations with regard to respective sets. For example, the UEAssistanceInformation message may include information regarding QoS requirements (for example, requirements regarding delay and reliability) corresponding to respective sets and traffic characteristics (for example, the cycle and data size).

QoS profile (CN->gNB) (1h-13): the core network (CN) 1h-05 may deliver, to the gNB, QoS profile information needed by the gNB 1h-03 to configure split bearer operations with regard to respective sets. The QoS profile may include information regarding QoS requirements (for example, requirements regarding delay and reliability) corresponding to respective sets and traffic characteristics (for example, the cycle and data size). The step 1h-13 of providing QoS profile information is not necessary performed in correspondence with the step 1h-12 of providing UEAssistanceInformation, and the core network (CN) 1h-05 may provide information regarding the QoS profile to the gNB 1h-03 at any time.

RRCReconfiguration (gNB->UE) (1h-14): the gNB 1h-03 may deliver a RRCReconfiguration message to the UE 1h-01 in order to configure split bearer operations with regard to respective sets. The RRCReconfiguration message may include the following parameters related to split bearer operation configurations, as described above with reference to FIG. 1G, with regard to respective sets. For example, the RRCReconfiguration message may include a primary path, a split secondary path, a secondary path, ul-DataSplitThreshold, pdcp-Duplication (or duplicationState), and the above example is not limitative.

In addition, according to an embodiment of the disclosure, in case that respective sets additionally have different QoS requirements, a discardTimer value may be configured with regard to respective sets for a packet discarding operation on the PDCP layer. The discardTimer value may be used for an operation of discarding the PDCP SDU packet corresponding to the pertinent set. For example, if a PDCP SDU packet arrives at the PDCP layer, the discard timer may start. If the discard timer value reaches the discardTimer value configured with regard to the set corresponding to the PDCP SDU packet, the timer may expire, thereby discarding the received PDCP SDU packet. If L2 transmission regarding the PDCP SDU packet succeeds prior to discardTimer expiration, the UE may end discardTimer and discard the PDCP SDU packet.

RRCReconfigurationComplete (UE->gNB) (1h-15): the UE 1h-01 may apply separate split bearer operation configurations with regard to respective sets according to the configurations included in the RRCReconfiguration message received from the gNB 1h-03 in step 1h-14, and may transmit a RRCReconfigurationComplete message to report completion of split bearer operation configurations to the gNB.
MAC CE for duplication activation/deactivation per set (gNB->UE) (1h-16): the gNB 1h-03 may transmit a MAC CE to the UE 1h-01 in order to activate or deactivate the split bearer's duplication operation configured with regard to respective sets. To this end, a legacy MAC CE based on the duplication activation/deactivation MAC CE structure (format) defined in 3GPP TS 38.321 standard document may be used (for example, UE operations may be changed upon receiving the MAC CE.), or a newly defined MAC CE structure may be used as will be described later with reference to FIG. 1I.
MAC CE for duplication RLC activation per set (gNB->UE) (1h-17): in case that there are two or more RLC entities that can be used as secondary paths (or secondary RLC paths) for duplication operations (or in case that there are three or more RLC entities connected to the corresponding DRB), the gNB 1h-03 may transmit a MAC CE to the UE 1h-01 in order to activate or deactivate duplication operations of respective RLC entities with regard to respective sets. To this end, a legacy MAC CE based on the duplication activation/deactivation MAC CE structure defined in 3GPP TS 38.321 standard document may be used (for example, UE operations may be changed upon receiving the MAC CE.), or a newly defined MAC CE structure may be used as will be described later with reference to FIG. 1I.

FIG. 1I illustrates a MAC CE structure that can be used to activate/deactivate PDCP duplication with regard to respective sets. FIG. 1I illustrates examples 1i-01, 1i-02, and 1i-03 of MAC CE structures that may be newly defined to activate or deactivate a duplication operation of a split bearer configured with regard to respective sets, as in step 1h-16.

In the first MAC CE structure 1i-01 in FIG. 1I, the DRB ID may indicate the DRB to which the MAC CE is to be applied, and each set_i value may indicate the duplication operation activation state regarding the corresponding set. Therefore, in case that a MAC CE is defined as in the first MAC CE structure 1i-01, duplication operation activation or deactivation may be indicated through one time of MAC CE transmission. In connection with set_i, i may indicate the set ID configured for the DRB indicated through the DRB ID, in ascending or descending order. In case that the set_i has a configured value of 1, this may indicate duplication function activation with regard to the corresponding set. In case that the set_i has a configured value of 0, this may indicate duplication function deactivation with regard to the corresponding set. Although it is assumed in this example that a maximum of three sets are transmitted through one DRB (three bits are used for the value of set_i), the MAC CE structure may be expanded such that, if four or more data sets can be transmitted through the same DRB, four or more bits may be used for the value of set_i.

In the second MAC CE structure 1i-02 in FIG. 1I, the DRB ID may indicate the DRB to which the MAC CE is to be applied, and the SET ID value may indicate the ID value of the set regarding which the duplication operation is to be activated or deactivated. Therefore, in case that a MAC CE is defined as in the second MAC CE structure 1i-02, duplication operation activation or deactivation regarding one set may be indicated through one time of MAC CE transmission. In case that duplication operations are to be simultaneously activated or deactivated with regard to multiple sets configured for a specific DRB by using the same structure, the structure 1i-02 may be expanded to include multiple SET IDs.

In the third MAC CE structure 1i-03 in FIG. 1I, each set_i value may indicate the duplication operation activation state regarding the set. Therefore, in case that a MAC CE is defined as in the third MAC CE structure 1i-03, duplication operation activation or deactivation regarding multiple sets may be indicated through one time of MAC CE transmission. In connection with set_i, i may indicate the set ID configured for the corresponding UE in ascending or descending order. (In this case, it is assumed that the set ID is uniquely configured in the corresponding UE.) In case that the set_i has a configured value of 1, this may indicate duplication function activation with regard to the corresponding set. In case that the set_i has a configured value of 0, this may indicate duplication function deactivation with regard to the corresponding set. Although it is assumed in this example that a maximum of eight sets are configured for the corresponding UE (eight bits are used for the value of set_i), the MAC CE structure may be expanded such that, if nine or more data sets can be configured for the same UE, nine or more bits may be used for the value of set_i.

The fourth MAC CE structure 1i-10 and the fifth MAC CE structure 1i-11 in FIG. 1I show MAC CE structures that can be used, in case that there are two or more RLC entities that can be used as secondary paths (or secondary RLC paths) for a duplication operation regarding a specific set (or in case that there are three or more RLC entities connected to the corresponding DRB), to activate or deactivate the duplication operation of respective RLC entities with regard to respective sets.

In the fourth MAC CE structure 1i-10 in FIG. 1I, the set ID may indicate the set to which the corresponding MAC CE is to be applied. (In this case, it is assumed that the set ID regarding each set is uniquely configured in the corresponding UE.). In addition, each RLC_i value may indicate the duplication operation activation state regarding each RLC entity. In connection with RLC_i, i may indicate the LCID value of RLC entities configured as secondary paths with regard to the set indicated through the set ID (or with regard to the DRB to be used to transmit the set indicated through the set ID), in ascending or descending order. In case that the RLC_i has a configured value of 1, this may indicate duplication function activation with regard to the RLC entity. In case that the RLC_i has a configured value of 0, this may indicate duplication function deactivation with regard to the RLC entity. Although it is assumed in this example that a maximum of three secondary paths are configured for one set (three bits are used for the value of RLC_i), the MAC CE structure may be expanded such that, if four or more RLC entities are configured as secondary paths regarding the corresponding set, four or more bits may be used for the value of RLC_i.

In the fifth MAC CE structure 1i-11 in FIG. 1I, the DRB ID and set ID may indicate the DRB and set, respectively, to which the corresponding MAC CE is to be applied. (In this case, it is assumed that the set ID regarding each set is uniquely configured with regard to each DRB.) In addition, each RLC_i value may indicate the duplication operation activation state regarding each RLC entity. In connection with RLC_i, i may indicate the LCID value of RLC entities configured as secondary paths with regard to the set indicated through the set ID (or with regard to the DRB indicated through the DRB ID), in ascending or descending order. In case that the RLC_i has a configured value of 1, this may indicate duplication function activation with regard to the RLC entity. In case that the RLC_i has a configured value of 0, this may indicate duplication function deactivation with regard to the RLC entity. Although it is assumed in this example that a maximum of eight secondary paths are configured for one set (eight bits are used for the value of RLC_i), the MAC CE structure may be expanded such that, if nine or more RLC entities are configured as secondary paths regarding the corresponding set, nine or more bits may be used for the value of RLC_i. Obviously, the above examples are not limitative, and a new MAC CE obtained by combining the five MAC CE structures described above may also be used.

FIG. 1J is a block diagram illustrating the internal structure of a UE according to an embodiment of the disclosure.

Referring to FIG. 1J, the UE includes a radio frequency (RF) processing unit 1j-10, a baseband processing unit 1j-20, a storage unit 1j-30, and a controller 1j-40. Obviously, the above example is not limitative, and the UE may include a smaller number of components than the components illustrated in FIG. 1J, or a larger number of components. The RF processing unit 1j-10 may perform functions for transmitting/receiving signals through a radio channel, such as signal band conversion and amplification. That is, the RF processing unit 1j-10 up-converts a baseband signal provided from the baseband processing unit 1j-20 to an RF band signal, transmits the same through an antenna, and down-converts an RF band signal received through the antenna to a baseband signal. For example, the RF processing unit 1j-10 may include a transmission filter, a reception filter, an amplifier, a mixer, an oscillator, a digital-to-analog converter (DAC), and an analog-to-digital converter (ADC) and the like. Although only one antenna is illustrated in FIG. 1J, the UE may include multiple antennas. In addition, the RF processing unit 1j-10 may include multiple RF chains. Furthermore, the RF processing unit 1j-10 may perform beamforming. For the beamforming, the RF processing unit 1j-10 may adjust the phase and magnitude of signals transmitted/received through multiple antennas or antenna elements, respectively. In addition, the RF processing unit 1j-10 may perform multi-input multi-output (MIMO), and may receive multiple layers when performing a MIMO operation. The RF processing unit 1j-10 may appropriately configure multiple antennas or antenna elements under the control of the controller 1j-40 so as to perform received beam sweeping, or may adjust the direction and beam width of received beams such that received beams are coordinated with transmitted beams.

The baseband processing unit 1j-20 may perform functions of conversion between baseband signals and bitstrings according to the system's physical layer specifications. For example, during data transmission, the baseband processing unit 1j-20 may encode and modulate a transmitted bitstring to generate complex symbols. In addition, during data reception, the baseband processing unit 1j-20 may demodulate and decode a baseband signal provided from the RF processing unit 1j-10 to restore a received bitstring. For example, when following the orthogonal frequency division multiplexing (OFDM) scheme, during data transmission, the baseband processing unit 1j-20 may encode and modulate a transmitted bitstring to generate complex symbols, may map the complex symbols to subcarriers, and may configure OFDM symbols through the inverse fast Fourier transform (IFFT) operation and cyclic prefix (CP) insertion. In addition, during data reception, the baseband processing unit 1j-20 may split a baseband signal provided from the RF processing unit 1j-10 at the OFDM symbol level, may restore signals mapped to subcarriers through the fast Fourier transform (FFT) operation, and may restore a received bitstring through demodulation and decoding.

The baseband processing unit 1j-20 and the RF processing unit 1j-10 may transmit and receive signals as described above. Therefore, the baseband processing unit 1j-20 and the RF processing unit 1j-10 may be referred to as a transmitter, a receiver, a transceiver, or a communication unit. Furthermore, at least one of the baseband processing unit 1j-20 and the RF processing unit 1j-10 may include multiple communication modules to support multiple different radio access technologies. In addition, at least one of the baseband processing unit 1j-20 and the RF processing unit 1j-10 may include different communication modules to process signals in different frequency bands. For example, the different radio access technologies may include wireless LANs (for example, IEEE 802.11), cellular networks (for example, LTE), and the like. In addition, the different frequency bands may include a super high frequency (SHF) (for example, 2.NRHz, NRhz) bands and millimeter wave (for example, 60 GHz) bands. The UE may transmit/receive signals with the gNB by using the baseband processing unit 1j-20 and the RF processing unit 1j-10, and signals may include control information and data.

The storage unit 1j-30 may store data such as basic programs for operations of the UE, application programs, and configuration information. Particularly, the storage unit 1j-30 may store information related to a second access node that performs radio communication by using second radio access technology. In addition, the storage unit 1j-30 may provide the stored data at the request of the controller 1j-40. In addition, the storage unit 1j-30 may be configured by multiple memories. According to an embodiment, the storage unit 1j-30 may store programs for performing the split bearer operating method of the disclosure.

The controller 1j-40 may control overall operations of the UE. For example, the controller 1j-40 may transmit/receive signals through the baseband processing unit 1j-20 and the RF processing unit 1j-10. In addition, the controller 1j-40 may record and read data in the storage unit 1j-40. To this end, the controller 1j-40 may include at least one processor. For example, the controller 1j-40 may include a communication processor (CP) configured to perform control for communication, and an application processor (AP) configured to control upper layers such as application programs. In addition, at least one component in the UE may be implemented as a single chip. In addition, according to an embodiment of the disclosure, the controller 1j-40 may include a multi-connection processing unit 1j-42 configured to perform processing for operating in a multi-connection mode.

FIG. 1K is a block diagram illustrating the configuration of a gNB according to an embodiment of the disclosure.

Referring to FIG. 1K, the gNB may include an RF processing unit 1k-10, a baseband processing unit 1k-20, a backhaul communication unit 1k-30, a storage unit 1k-40, and a controller 1k-50. Obviously, the above example is not limitative, and the gNB may include a smaller number of components than the components illustrated in FIG. 1K, or a larger number of components.

The RF processing unit 1k-10 may perform functions for transmitting/receiving signals through a radio channel, such as signal band conversion and amplification. That is, the RF processing unit 1k-10 may up-convert a baseband signal provided from the baseband processing unit 1k-20 to an RF band signal, may transmit the same through an antenna, and may down-convert an RF band signal received through the antenna to a baseband signal. For example, the RF processing unit 1k-10 may include a transmission filter, a reception filter, an amplifier, a mixer, an oscillator, a DAC, and an ADC. Although only one antenna is illustrated in FIG. 1k, the gNB include multiple antennas. In addition, the RF processing unit 1k-10 may include multiple RF chains. Furthermore, the RF processing unit 1k-10 may perform beamforming. For the beamforming, the RF processing unit 1k-10 may adjust the phase and magnitude of signals transmitted/received through multiple antennas or antenna elements, respectively. The RF processing unit 1k-10 may transmit one or more layers to perform downward MIMO operations. The RF processing unit 1k-10 may appropriately configure multiple antennas or antenna elements under the control of the controller so as to perform received beam sweeping, or may adjust the direction and beam width of received beams such that received beams are coordinated with transmitted beams.

The baseband processing unit 1k-20 may perform functions of conversion between baseband signals and bitstrings according to the physical layer specifications of first radio access technology. For example, during data transmission, the baseband processing unit 1k-20 may encode and modulate a transmitted bitstring to generate complex symbols. In addition, during data reception, the baseband processing unit 1k-20 may demodulate and decode a baseband signal provided from the RF processing unit 1k-10 to restore a received bitstring. For example, when following the OFDM scheme, during data transmission, the baseband processing unit 1k-20 may encode and modulate a transmitted bitstring to generate complex symbols, may map the complex symbols to subcarriers, and may configure OFDM symbols through the IFFT operation and CP insertion. In addition, during data reception, the baseband processing unit 1k-20 may split a baseband signal provided from the RF processing unit 1k-10 at the OFDM symbol level, may restore signals mapped to subcarriers through the FFT operation, and may restore a received bitstring through demodulation and decoding. The baseband processing unit 1k-20 and the RF processing unit 1k-10 may transmit and receive signals as described above. Therefore, the baseband processing unit 1k-20 and the RF processing unit 1k-10 may be referred to as a transmitter, a receiver, a transceiver, a communication unit, or a wireless a communication unit. The gNB may transmit/receive signals with the UE by using the baseband processing unit 1k-20 and the RF processing unit 1k-10, and signals may include control information and data.

The backhaul communication unit 1k-30 may provide an interface for communicating with other nodes in the network. That is, backhaul communication unit 1k-30 may convert bitstrings transmitted from the main gNB to other nodes (for example, auxiliary gNB, core network, and the like) into physical signals, and may convert physical signals received from other nodes into bitstrings.

The storage unit 1k-40 may store data such as basic programs for operations of the gNB, application programs, and configuration information. Particularly, the storage unit 1k-40 may store information regarding a bearer allocated to a connected UE, a measurement result reported from the connected UE, and the like. In addition, the storage unit 1k-40 may store information serving as a reference to determine whether to provide multi-connection to a UE or to suspend the same. In addition, the storage unit 1k-40 may provide the stored data at the request of the controller 1k-50. The storage unit 1k-40 may store programs for performing the split bearer operating method of the disclosure.

The controller 1k-50 may control overall operations of the gNB. For example, the controller 1k-50 may transmit/receive signals through the baseband processing unit 1k-20 and the RF processing unit 1k-10 or through the backhaul communication unit 1k-30. In addition, the controller 1k-50 may record and read data in the storage unit 1k-40. To this end, the controller 1k-50 may include at least one processor. In addition, at least one component in the gNB may be implemented as a single chip. In addition, at least one component in the gNB may be implemented as a single chip. In addition, respective components of the gNB may operate to perform the above-described embodiments of the disclosure.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a terminal in a wireless communication system, the method comprising:
receiving, from a base station, configuration information for configuring a radio link control (RLC) bearer for a first data set and a second data set;
identifying the first data set and the second data set included in one data radio bearer (DRB);
allocating the first data set and the second data set to multiple RLC bearers, based on the configuration information; and
transmitting the first data set and the second data set through the multiple RLC bearers, wherein the first data set and the second data set have different quality of service (QoS) requirements.

2. The method of claim 1, further comprising:
receiving, from the base station, a UECapabilityEnquiry message requesting information regarding whether a data set-based bearer configuration is supported; and
transmitting, to the base station, a UECapabilityInformation message comprising the information regarding whether a data set-based bearer configuration is supported.

3. The method of claim 1,
wherein the configuration information comprises a first threshold for determining whether or not to operate a split bearer for the first data set and a second threshold for determining whether or not to operate a split bearer for the second data set, and
wherein the allocating of the first data set and the second data set to multiple RLC bearers, based on the configuration information, comprises:
determining, based on the first threshold, at least one RLC bearer among the multiple RLC bearers as a first primary path and a first split secondary path for the first data set;
determining, based on the second threshold, at least one RLC bearer among the multiple RLC bearers as a second primary path and a second split secondary path for the second data set;
allocating the first data set to the first primary path, and the first split secondary path; and
allocating the second data set to the second primary path, and the second split secondary path.

4. The method of claim 3, wherein the RLC bearers determined as the first primary path, the second split secondary path, the second primary path, and the second split secondary path are different from each other.

5. The method of claim 1,
wherein the configuration information comprises first duplication information regarding whether or not duplication is configured with regard to the first data set and second duplication information regarding whether or not duplication is configured with regard to the second data set, and
wherein the allocating of the first data set and the second data set to multiple RLC bearers, based on the configuration information, comprises:
determining, based on the first duplication information, at least one RLC bearer among the multiple RLC bearers as a first primary path and a first secondary path for the first data set;
determining, based on the second duplication information, at least one RLC bearer among the multiple RLC bearers as a second primary path and a second secondary path for the second data set;
allocating the first data set to the first primary path, and the first secondary path; and
allocating the second data set to the second primary path, and the second secondary path.

6. The method of claim 5, wherein the RLC bearers determined as the first primary path, the second secondary path, the second primary path, and the second secondary path are different from each other.

7. The method of claim 1, wherein the identifying of the first data set and the second data set included in one DRB comprises identifying the first data set and the second data set, based on identification information included in a header in a packet, or an internal interface of the terminal.

8. The method of claim 1, further comprising:
receiving a media access control (MAC) control element (CE) indicating whether to activate or deactivate a duplication function for at least one data set among the first data set and the second data set; and
base on the MAC CE, activating or deactivating a function of duplicating at least one data set among the first data set and the second data set and transmitting the duplicated data set to the multiple RLCs, based on the MAC CE.

9. A method performed by a base station in a wireless communication system, the method comprising:
transmitting, to a terminal, configuration information for configuring a radio link control (RLC) bearer with regard to each of a first data set and a second data set; and
receiving the first data set and the second data set allocated to multiple RLC bearers, based on the configuration information,
wherein the first data set and the second data set have different quality of service (QoS) requirements.

10. The method of claim 9, further comprising:
transmitting, to the terminal, a UECapabilityEnquiry message requesting information regarding whether a data set-based bearer configuration is supported; and
receiving, from the terminal, a UECapability Information message comprising the information regarding whether a data set-based bearer configuration is supported.

11. A terminal of a wireless communication system, the terminal comprising:
a transceiver; and
at least one processor coupled to the transceiver,
wherein the at least one processor is configured to:
receive, from a base station, configuration information for configuring a radio link control (RLC) bearer for a first data set and a second data set;
identify the first data set and the second data set included in one data radio bearer (DRB);
allocate the first data set and the second data set to multiple RLC bearers, based on the configuration information; and
transmit the first data set and the second data set through the multiple RLC bearers, and
wherein the first data set and the second data set have different quality of service (QoS) requirements.

12. The terminal of claim 11, wherein the at least one processor is configured to:
receive, from the base station, a UECapabilityEnquiry message requesting information regarding whether a data set-based bearer configuration is supported; and
transmit, to the base station, a UECapabilityInformation message comprising the information regarding whether a data set-based bearer configuration is supported.

13. The terminal of claim 11,
wherein the configuration information comprises a first threshold for determining whether or not to operate a split bearer for the first data set and a second threshold for determining whether or not to operate a split bearer for the second data set, and
wherein the at least one processor is configured to:
determine, based on the first threshold, at least one RLC bearer among the multiple RLC bearers as a first primary path and a first split secondary path for the first data set;
determine, based on the second threshold, at least one RLC bearer among the multiple RLC bearers as a second primary path and a second split secondary path for the second data set;
allocate the first data set to the first primary path, and the first split secondary path; and
allocate the second data set to the second primary path, and the second split secondary path.

14. The terminal of claim 11,
wherein the configuration information comprises first duplication information regarding whether or not duplication is configured with regard to the first data set and second duplication information regarding whether or not duplication is configured with regard to the second data set, and
wherein the at least one processor is configured to:
determine, based on the first duplication information, at least one RLC bearer among the multiple RLC bearers as a first primary path and a first secondary path for the first data set;
determine, based on the second duplication information, at least one RLC bearer among the multiple RLC bearers as a second primary path and a second secondary path for the second data set;
allocate the first data set to the first primary path, and the first secondary path; and
allocate the second data set to the second primary path, and the second secondary path.

15. A base station of a wireless communication system, the base station comprising:
a transceiver; and
at least one processor coupled to the transceiver,
wherein the at least one processor is configured to:
transmit, to a terminal, configuration information for configuring a radio link control (RLC) bearer with regard to each of a first data set and a second data set; and
receive the first data set and the second data set allocated to multiple RLC bearers, based on the configuration information, and
wherein the first data set and the second data set have different quality of service (QoS) requirements.
